(19) United States
(12) Patent Application Publication
(10) Pub. No.: US 2025/0372642 A1
(43) Pub. Date: Dec. 4, 2025

(54) Positive Electrode Active Material, Secondary Battery, and Method of Producing Positive Electrode Active Material

(71) Applicant: TOYOTA JIDOSHA KABUSHIKI KAISHA, Toyota-shi Aichi-ken (JP)

(72) Inventors: Ryosuke OHSAWA, Okazaki-shi Aichi-ken (JP); Takahiko NINOMIYA, Miyoshi-shi Aichi-ken (JP); Taku KINOSHITA, Toyota-shi Aichi-ken (JP)

(73) Assignee: TOYOTA JIDOSHA KABUSHIKI KAISHA, Toyota-shi Aichi-ken (JP)

(21) Appl. No.: 19/218,766

(22) Filed: May 27, 2025

(30) Foreign Application Priority Data
May 31, 2024 (JP) 2024-089001

(51) Int. Cl. H01M 4/525; C01G 51/42; C01G 53/504; C01G 53/506

(52) U.S. Cl. CPC H01M 4/525; C01G 51/42; C01G 53/504; C01G 53/506; C01P 2002/52; C01P 2002/90; C01P 2006/16; C01P 2006/40

(57) ABSTRACT

A positive electrode active material comprises a secondary particle. The secondary particle includes crystallites. The crystallites extend radially from a center of the secondary particle toward outside. Each of the crystallites includes a lithium-metal composite oxide. The lithium-metal composite oxide has a lamellar-rock-salt-type structure. In a surface of the secondary particle, an open pore is formed between the crystallites that are adjacent to each other. The open pore has a pore diameter of 20 nm or more.

### CROSS REFERENCE TO RELATED APPLICATIONS

This nonprovisional application is based on Japanese Patent Application No. 2024-089001 filed on May 31, 2024, with the Japan Patent Office, the entire contents of which are hereby incorporated by reference.

### BACKGROUND OF THE DISCLOSURE

### Field of the Disclosure

The present disclosure relates to a positive electrode active material, a secondary battery, and a method of producing a positive electrode active material.

### Description of the Background Art

Japanese Patent Laying-Open No. 2019-145204 discloses a positive electrode active material comprising pores at a rate of 20% or more, wherein the pores include long pores that reach inside the particles.

### SUMMARY OF THE DISCLOSURE

The secondary particle structure of a positive electrode active material sometimes affects battery performance. For example, by forming a long pore that reaches inside the secondary particle, it is possible to enhance output properties. However, there may still be room for improvement in the endurance of batteries.

An object of the present disclosure is to enhance endurance.

Hereinafter, the technical configuration and effects of the present disclosure will be described. It should be noted that the action mechanism according to the present disclosure includes presumption. The action mechanism does not limit the technical scope of the present disclosure.
1. A positive electrode active material comprises a secondary particle. The secondary particle includes crystallites. The crystallites extend radially from a center of the secondary particle toward outside. Each of the crystallites includes a lithium-metal composite oxide. The lithium-metal composite oxide has a lamellar-rock-salt-type structure. In a surface of the secondary particle, an open pore is formed between the crystallites that are adjacent to each other. The open pore has a pore diameter of 20 nm or more.

FIG. 1 is a conceptual view illustrating a first example of a secondary particle structure. A secondary particle 2 is a group of crystallites 1. Crystallites 1 are also called “primary particles”. In secondary particle 2, crystallites 1 are densely packed. Crystallites 1 adjacent to each other bind to each other. During repeated charge and discharge, crystallites 1 expand and shrink repeatedly. Due to the volume change of crystallites 1, stress tends to be concentrated between crystallites 1. Due to the concentration of stress, crystallites 1 may become detached from each other. As a result, a nascent surface may be exposed. The nascent surface may be active. When the nascent surface reacts with the electrolyte, endurance may be degraded.

FIG. 2 is a conceptual view illustrating a second example of a secondary particle structure. Crystallites 1 extend radially. In the surface of secondary particle 2, open pores 3 are formed between crystallites 1. Due to the combination of the radial arrangement of crystallites 1 and open pores 3 in the surface of the particle, stress generated by volume changes of crystallites 1 may be reduced. As a result, detachment between crystallites 1 (exposure of nascent surfaces) is expected to be reduced. In other words, endurance is expected to be enhanced. It should be noted that open pore 3 has a pore diameter of 20 nm or more. When the pore diameter is less than 20 nm, there is a possibility that a desired level of endurance may not be obtained.
2. The positive electrode active material according to “1” above may include the following configuration, for example. In a cross section of the secondary particle, a relationship of “θ≤45°” is satisfied. “0” represents an angle formed by a first straight line and a second straight line. The first straight line is an extension of a major-axis diameter of the crystallite. The second straight line passes both a point of intersection between the extension and a circumcircle of the secondary particle, and a center of the circumcircle.

The angle (θ) is an index of the arrangement. It is conceivable that the smaller the angle (θ) is, the more radially the crystallites extend. With the angle (θ) being 45° or less, endurance is expected to be enhanced.
3. The positive electrode active material according to “1” or “2” above may include the following configuration, for example. The pore diameter of the open pore is less than 250 nm.

When the pore diameter is less than 250 nm, endurance is expected to be enhanced.
4. The positive electrode active material according to any one of “1” to “3” above may include the following configuration, for example. In a cross section of the secondary particle, a relationship of “6.4≤d_{L}/d_{S}≤17.3” is satisfied. “d_{L}” represents a major-axis diameter of the crystallite. “d_{S}” represents a minor-axis diameter of the crystallite.

“d_{L}/d_{S}” represents the aspect ratio of the crystallite. When the aspect ratio is from 6.4 to 17.3, endurance is expected to be enhanced.
5. The positive electrode active material according to any one of “1” to “4” above may include the following configuration, for example. In a cross section of the secondary particle, a relationship of “4.0≤D/d_{L}≤9.0” is satisfied. “D” represents a maximum Feret diameter of the secondary particle. “d_{L}” represents a major-axis diameter of the crystallite.

“D/d_{L}” represents the size ratio between the secondary particle and the crystallite. When the size ratio is from 4 to 9, endurance is expected to be enhanced.
6. The positive electrode active material according to any one of “1” to “5” above may include the following configuration, for example. The lithium-metal composite oxide has a composition represented by the following general formula.

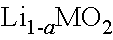

In the formula, a relationship of “−0.5≤a≤0.5” is satisfied. M includes at least one selected from the group consisting of Ni, Co, Mn, and Al.
7. The positive electrode active material according to any one of “1” to “5” above may include the following configuration, for example. The lithium-metal composite oxide has a composition represented by the following general formula.

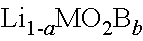

In the formula, relationships of “−0.5≤a≤0.5” and “0.002≤b≤0.030” are satisfied. M includes at least one selected from the group consisting of Ni, Co, Mn, and Al.

For example, the lithium-metal composite oxide may include a certain amount of boron (B). For example, B may be derived from a crystal-control material described below.
8. A secondary battery comprises the positive electrode active material according to any one of “1” to “7” above.
9. A method of producing a positive electrode active material comprises the following (a) to (d):
(a) preparing a metal hydroxide;
   (b) mixing the metal hydroxide, a lithium compound, and a crystal-control material to form a first mixture;
   (c) performing a first heat treatment of the first mixture to form a second mixture; and
   (d) performing a second heat treatment of the second mixture to synthesize a positive electrode active material.

The crystal-control material includes B₂O₃. Each of the first heat treatment and the second heat treatment is performed in an oxygen atmosphere. The first heat treatment is performed at a temperature from 600 to 700° C. for 6 to 12 hours. The second heat treatment is performed at a temperature from 1100 to 1300° C. for 1 to 3 hours.

It is expected that the combination of the crystal-control material (B₂O₃), the first heat treatment, and the second heat treatment allows for formation of the secondary particle structure according to “1” above.

In the following, an embodiment of the present disclosure (which may also be simply called “the present embodiment” hereinafter) and an example of the present disclosure (which may also be simply called “the present example” hereinafter) will be described. It should be noted that neither the present embodiment nor the present example limits the technical scope of the present disclosure. The present embodiment and the present example are illustrative in any respect. The present embodiment and the present example are non-restrictive. The technical scope of the present disclosure encompasses any modifications within the meaning and the scope equivalent to the terms of the claims. For example, it is originally planned that any configurations of the present embodiment may be optionally combined.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a conceptual view illustrating a first example of a secondary particle structure.

FIG. 2 is a conceptual view illustrating a second example of a secondary particle structure.

FIG. 3 is a conceptual view illustrating an example of a cross-sectional image of a secondary particle according to the present embodiment.

FIG. 4 is a conceptual view illustrating a method for measuring an angle (θ).

FIG. 5 is a schematic flowchart illustrating a method of producing a positive electrode active material according to the present embodiment.

FIG. 6 is a conceptual view illustrating a secondary battery according to the present embodiment.

FIG. 7 is a table showing a first battery configuration.

FIG. 8 is a table showing a second battery configuration.

FIG. 9 is a table showing a third battery configuration.

FIG. 10 is a table showing experiment results.

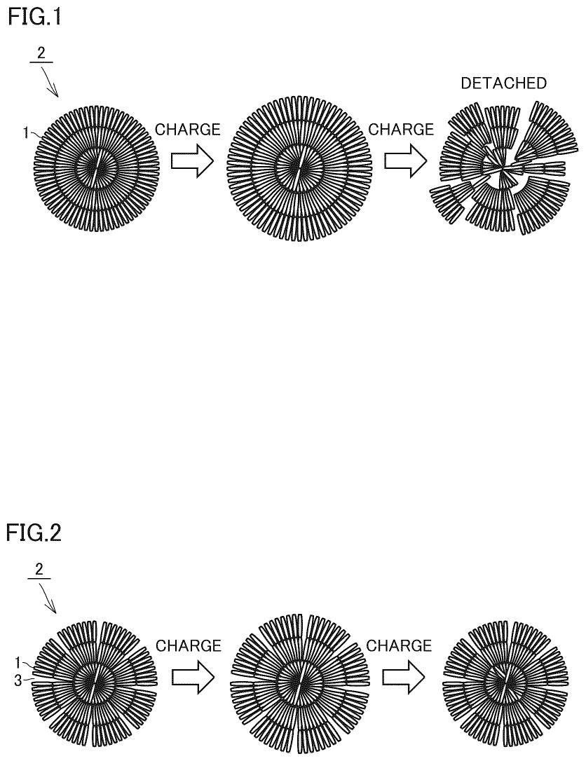

### DESCRIPTION OF THE EMBODIMENTS

### <Terms and Phrases>

Terms such as “comprise”, “include”, and “have”, and other similar terms are open-ended terms. In an open-ended term, in addition to a stated component, an additional component may or may not be further included. The term “consist of” is a closed-end term. However, even in a configuration that is expressed by a closed-end term, impurities present under ordinary circumstances as well as an additional element irrelevant to the technique of interest may be included. The term “consist essentially of” is a semiclosed-end term. A semiclosed-end term tolerates addition of an element that does not substantially affect the fundamental, novel features of the technique of interest.

Expressions such as “may” and “can” are not intended to mean “must” (obligation) but rather mean “there is a possibility” (tolerance).

Regarding a plurality of steps, operations, processes, and the like that are included in various methods, the order for implementing those things is not limited to the described order, unless otherwise specified. For example, a plurality of steps may proceed simultaneously. For example, a plurality of steps may be implemented in reverse order.

Any geometric term should not be interpreted solely in its exact meaning. Examples of geometric terms include “parallel”, “vertical”, “orthogonal”, and the like. For example, “parallel” may mean a geometric state that is deviated, to some extent, from exact “parallel”. For example, as long as substantially the same function is obtained, the relative direction, angle, distance, and the like may vary. Any geometric term herein may include tolerances and/or errors in terms of design, operation, production, and/or the like. The dimensional relationship in each figure may not necessarily coincide with the actual dimensional relationship. For the purpose of assisting understanding for the readers, the dimensional relationship in each figure may have been changed. For example, length, width, thickness, and the like may have been changed. A part of a given configuration may have been omitted.

A numerical range such as “from m to n %” includes both the upper limit and the lower limit, unless otherwise specified. That is, “from m to n %” means a numerical range of “not less than m % and not more than n %”. Moreover, “not less than m % and not more than n %” includes “more than m % and less than n %”. Each of “not less than” and “not more than” is represented by an inequality symbol with an equality symbol, e.g., “≤”. Each of “more than” and “less than” is represented by an inequality symbol without an equality symbol, e.g., “<”. Any numerical value selected from a certain numerical range may be used as a new upper limit or a new lower limit. For example, any numerical value from a certain numerical range may be combined with any numerical value described in another location of the present specification or in a table or a drawing to set a new numerical range.

All the numerical values are regarded as being modified by the term “about”. The term “about” may mean ±5%, ±3%, ±1%, and/or the like, for example. Each numerical value may be an approximate value that can vary depending on the implementation configuration of the technique according to the present disclosure. Each numerical value may be expressed in significant figures. Unless otherwise specified, each measured value may be the average value obtained from multiple measurements performed. The number of measurements may be 3 or more, or may be 5 or more, or may be 10 or more. Generally, the greater the number of measurements is, the more reliable the average value is expected to be. Each measured value may be rounded off based on the number of the significant figures. Each measured value may include an error occurring due to an identification limit of the measurement apparatus, for example.

“Crystallite” refers to a solid particle that is the smallest constituent unit of a particle, and it is recognized that the boundary between them cannot be split any further. “Secondary particle” refers to a group of two or more crystallites.

Each of “the pore diameter (Pd) of an open pore”, “the major-axis diameter (d_{L}) of a crystallite”, “the minor-axis diameter (d_{S}) of a crystallite”, “the maximum Feret diameter (D) of a secondary particle”, and “the angle (θ)” is measured in a cross-sectional SEM (Scanning Electron Microscope) image of the secondary particle. The magnification may be adjusted to suit the particle size. The magnification may be about 1000 times, for example. A cross-sectional sample of a particle may be prepared by a conventionally known method. For example, a cross-sectional sample may be prepared with a cross section polisher (CP), focused ion beam (FIB), and/or the like. Various dimensions and angles in the image are measured with the use of image analysis software. For example, “ImageJ Fiji” and/or the like may be used. It should be noted that “ImageJ Fiji” is merely an example. Any image analysis software may be used as long as it has functions equivalent to “ImageJ Fiji”. For example, image analysis software included with various SEM apparatuses may be used.

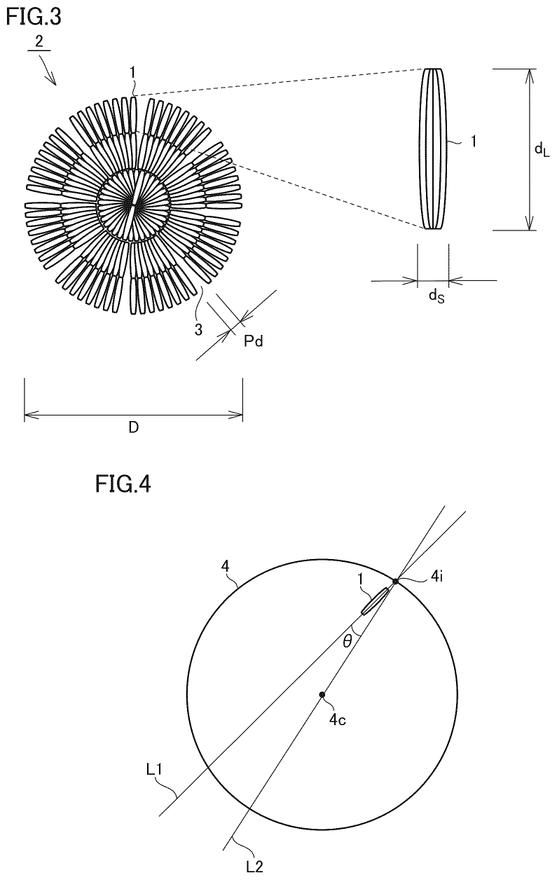

FIG. 3 is a conceptual view illustrating an example of a cross-sectional image of a secondary particle according to the present embodiment. In a cross-sectional SEM image of a secondary particle 2, the surface of the secondary particle 2 is examined. Pores formed between crystallites 1 and open to the outside air are “open pores 3”. The diameter of the opening of open pore 3 is “the pore diameter (Pd)”.

The distance between two points located farthest apart from each other on the outline of secondary particle 2 is “the maximum Feret diameter (D)”.

The smallest rectangle that circumscribes a crystallite 1 (hereinafter also called “a circumscribing rectangle”) is identified. The length of the long side of the circumscribing rectangle is “the major-axis diameter (d_{L})”. The length of the short side of the circumscribing rectangle is “the minor-axis diameter (d_{S})”.

FIG. 4 is a conceptual view illustrating a method for measuring the angle (θ). In a cross-sectional SEM image of a secondary particle, a circumcircle 4 of the secondary particle is identified. A crystallite 1 exposed on the surface of the secondary particle is selected. The major-axis diameter (d_{L}) of the crystallite 1 is extended to draw a first straight line L1. That is, first straight line L1 is an extension of the major-axis diameter (d_{L}). The point of intersection (an intersection point 4i) between first straight line L1 and circumcircle 4 is identified. A second straight line L2 that passes the intersection point 4i and a center 4c of circumcircle 4 is identified. The angle (θ) is the angle (an acute angle) formed by first straight line L1 and second straight line L2.

“D50” refers to a particle size in volume-based particle size distribution (cumulative distribution) at which the cumulative value reaches 50%. The particle size distribution may be measured by laser diffraction.

A stoichiometric composition formula represents a typical example of a compound. A compound may have a non-stoichiometric composition. For example, “Al₂O₃” is not limited to a compound where the ratio of the amount of substance (molar ratio) is “Al/O=⅔”. “Al₂O₃” represents a compound that includes Al and O in any molar ratio, unless otherwise specified. For example, the compound may be doped with a trace element. Some of Al and O may be replaced by another element.

“Derivative” refers to a compound that is derived from its original compound by at least one partial modification selected from the group consisting of substituent introduction, atom replacement, oxidation, reduction, and other chemical reactions. The position of modification may be one position, or may be a plurality of positions. “Substituent” may include, for example, at least one selected from the group consisting of alkyl group, alkenyl group, alkynyl group, cycloalkyl group, unsaturated cycloalkyl group, aromatic group, heterocyclic group, halogen atom (F, Cl, Br, I, etc.), OH group, SH group, CN group, SCN group, OCN group, nitro group, alkoxy group, unsaturated alkoxy group, amino group, alkylamino group, dialkylamino group, aryloxy group, acyl group, alkoxycarbonyl group, acyloxy group, aryloxycarbonyl group, acylamino group, alkoxycarbonylamino group, aryloxy carbonylamino group, sulfonylamino group, sulfamoyl group, carbamoyl group, alkylthio group, arylthio group, sulfonyl group, sulfinyl group, ureido group, phosphoramide group, sulfo group, carboxy group, hydroxamic acid group, sulfino group, hydrazino group, imino group, silyl group, and the like. These substituents may be further substituted. When there are two or more substituents, these substituents may be the same as one another or may be different from each other. A plurality of substituents may be bonded together to form a ring. A derivative of a polymer compound (a resin material) may also be called “a modified product”.

“Copolymer” includes at least one selected from the group consisting of unspecified-type, statistical-type, random-type, alternating-type, periodic-type, block-type, and graft-type.

### <Positive Electrode Active Material>

In the following, the positive electrode active material according to the present embodiment may be simply referred to as “the present positive electrode active material”. The present positive electrode active material is for a secondary battery. The positive electrode active material comprises secondary particles. The positive electrode active material may be a group of secondary particles (powder). The D50 of the present positive electrode active material may be 0.1 μm or more, or 1 μm or more, or 5 μm or more, or 10 μm or more, for example. The D50 may be 30 μm or less, or 25 μm or less, or 20 μm or less, or 15 μm or less, or 10 μm or less, for example.

### Secondary Particles

As illustrated in FIG. 3, secondary particle 2 is a group of crystallites 1. The shape of secondary particle 2 is not particularly limited. Secondary particle 2 may be a sphere, an elliptical sphere, a lump, and/or the like, for example. In a cross-sectional SEM image of a secondary particle 2, the contour of the secondary particle 2 may have a circularity of 0.8 or more, for example. The circularity may be 0.85 or more, or 0.90 or more, or 0.95 or more, for example. “Circularity” is determined by the following equation.

$$C r = 4 π S / {L}^{2}$$

Cr: Circularity
π: Circular constant
S: Cross-sectional area of secondary particle 2 (the area of a region surrounded by the contour of secondary particle 2)

L: Perimeter of secondary particle 2 (the length of the contour of secondary particle 2)

The maximum Feret diameter (D) of secondary particle 2 may be 1 μm or more, or 5 μm or more, or 10 μm or more, or 12.8 μm or more, or 13.2 μm or more, or 13.5 μm or more, or 14.8 μm or more, or 17.3 μm or more, or 20 μm or more, for example. The maximum Feret diameter (D) may be 30 μm or less, or 25 μm or less, or 20 μm or less, or 17.3 μm or less, or 14.8 μm or less, or 13.5 μm or less, or 13.2 μm or less, or 12.8 μm or less, or 10 μm or less, for example.

### Crystallite

Secondary particle 2 includes crystallites 1. In a cross-sectional SEM image of a secondary particle 2, the number of crystallites 1 included in one secondary particle 2 may be 10 or more, or 50 or more, or 100 or more, or 150 or more, or 200 or more, for example. The number of crystallites 1 included in one secondary particle 2 may be 500 or less, or 250 or less, or 200 or less, or 150 or less, or 100 or less, or 50 or less, for example.

For example, the relationship of 4.0≤D/d_{L}≤9.0 may be satisfied. The size ratio (D/d_{L}) may be 5.1 or more, or 5.5 or more, or 6.8 or more, for example. The size ratio (D/d_{L}) may be 6.8 or less, or 5.5 or less, or 5.1 or less, for example.

Crystallite 1 may be rod-like, columnar, needle-like, and/or the like, for example. The relationship of 6.4≤d_{L}/d_{S}≤17.3 may be satisfied, for example. The aspect ratio (d_{L}/d_{S}) of crystallite 1 may be 7.5 or more, or 10.4 or more, or 13.5 or more, for example. The aspect ratio (d_{L}/d_{S}) may be 13.5 or less, or 10.4 or less, or 7.5 or less, for example.

Crystallites 1 extend radially from the center of secondary particle 2 toward outside. The relationship of θ≤45° may be satisfied, for example. The angle (θ) may be 47.3° or less, or 44.3° or less, or 30° or less, or 26.8° or less, or 15° or less, or 10° or less, or 5.6° or less, or 2.1° or less, or 1° or less, for example. The angle (θ) may be 0° or more, or 1° or more, or 2.1° or more, or 5.6° or more, or 10° or more, or 15° or more, or 26.8° or more, or 30° or more, or 44.3° or more, for example.

### Open Pore

In the surface of secondary particle 2, an open pore 3 is formed between crystallites 1 that are adjacent to each other. Open pore 3 may extend from the surface of the particle toward the center of the particle. Open pore 3 has a pore diameter (Pd) of 20 nm or more. The pore diameter (Pd) may be 50 nm or more, or 87 nm or more, or 100 nm or more, or 150 nm or more, or 175 nm or more, or 200 nm or more, or 248 nm or more, for example. The pore diameter (Pd) may be less than 250 nm, or 248 nm or less, or 200 nm or less, or 175 nm or less, or 150 nm or less, or 100 nm or less, or 87 nm or less, or 50 nm or less, for example. That is, the relationship of 20 nm≤Pd<250 nm may be satisfied.

The maximum depth of open pore 3 from the surface of secondary particle 2 may be 0.01 D or more, or 0.05 D or more, or 0.1 D or more, or 0.2 D or more, or 0.3 D or more, or 0.4 D or more, for example. “D” represents the maximum Feret diameter of secondary particle 2. For example, “0.1 D” means 0.1 times the value of D. The maximum depth of open pore 3 may be 0.5 D or less, or 0.4 D or less, or 0.3 D or less, or 0.2 D or less, or 0.1 D or less, or 0.05 D or less, for example.

### Crystal Structure

Crystallite 1 may consist of one crystal (a single crystal). The lithium-metal composite oxide has a lamellar-rock-salt-type structure. A lamellar-rock-salt-type structure is also called “an α-NaFeO₂-type structure”. The space group for a lamellar-rock-salt-type structure is “R−3m”. It should be noted that the bar “−” should be placed above “3” but for the sake of convenience, it is placed in front of “3”. The crystal structure may be identified by powder X-ray diffraction (XRD). A lamellar-rock-salt-type structure has a 100 plane and a 003 plane. At an end face of crystallite 1 (columnar), a 100 plane may be detected. At a side face (a peripheral surface) of crystallite 1, a 003 plane may be detected. The crystal face may be detected by transmission electron microscopy (TEM) analysis, for example.

### Chemical Composition

The lithium-metal composite oxide may have any chemical composition. The lithium-metal composite oxide may have a composition represented by the following general formula, for example.

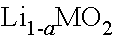

In the formula, the relationship of −0.5≤a≤0.5 is satisfied. M includes at least one selected from the group consisting of Ni, Co, Mn, and Al.

The lithium-metal composite oxide may be doped with B and/or the like. In other words, the lithium-metal composite oxide may have a composition represented by the following general formula, for example.

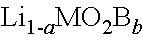

In the formula, the relationships of −0.5≤a≤0.5 and 0.002≤b≤0.030 are satisfied. M includes at least one selected from the group consisting of Ni, Co, Mn, and Al. For example, the relationship of 0.002≤b≤0.005, 0.005≤b≤0.010, or 0.010≤b≤0.030 may be satisfied.

B may be diffused throughout the entire particle, or may be locally distributed. For example, B may be locally distributed on the particle surface. B may be a substituted solid solution atom, or may be an intruding solid solution atom.

The composition of the lithium-metal composite oxide may be represented by the following general formula, for example.

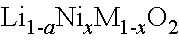

In the above formula, the relationships of −0.5≤a≤0.5, 0≤x≤1 are satisfied. M may include, for example, at least one selected from the group consisting of Co, Mn, and Al. For example, the relationship of 0<x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x≤1 may be satisfied. For example, the relationship of −0.4≤a≤0.4, −0.3≤a≤0.3, −0.2≤a≤0.2, or −0.1≤a≤0.1 may be satisfied.

The lithium-metal composite oxide may include, for example, at least one selected from the group consisting of LiCoO₂, LiMnO₂, LiNi_{0.9}Co_{0.1}O₂, LiNi_{0.9}Mn_{0.1}O₂, and LiNiO₂.

The composition of the lithium-metal composite oxide may be represented by the following general formula, for example. A compound represented by the following general formula may also be called “NCM”.

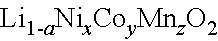

In the above formula, the relationships of −0.5≤a≤0.5, 0<x<1, 0<y<1, 0<z<1, x+y+z=1 are satisfied. For example, the relationship of 0<x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x<1 may be satisfied. For example, the relationship of 0<y≤0.1, 0.1≤y≤0.2, 0.2≤y≤0.3, 0.3≤y≤0.4, 0.4≤y≤0.5, 0.5≤y≤0.6, 0.6≤y≤0.7, 0.7≤y≤0.8, 0.8≤y≤0.9, or 0.9≤y<1 may be satisfied. For example, the relationship of 0<z≤0.1, 0.1≤z≤0.2, 0.2≤z≤0.3, 0.3≤z≤0.4, 0.4≤z≤0.5, 0.5≤z≤0.6, 0.6≤z≤0.7, 0.7≤z≤0.8, 0.8≤z≤0.9, or 0.9≤z<1 may be satisfied.

NCM may include, for example, at least one selected from the group consisting of LiNi_{1/3}Co_{1/3}Mn_{1/3}O₂, LiNi_{0.4}Co_{0.3}Mn_{0.3}O₂, LiNi_{0.3}Co_{0.4}Mn_{0.3}O₂, LiNi_{0.3}Co_{0.3}Mn_{0.4}O₂, LiNi_{0.5}Co_{0.2}Mn_{0.3}O₂, LiNi_{0.5}Co_{0.3}Mn_{0.2}O₂, LiNi_{0.5}Co_{0.4}Mn_{0.1}O₂, LiNi_{0.5}Co_{0.1}Mn_{0.4}O₂, LiNi_{0.6}Co_{0.2}Mn_{0.2}O₂, LiNi_{0.6}Co_{0.3}Mn_{0.1}O₂, LiNi_{0.6}Co_{0.1}Mn_{0.3}O₂, LiNi_{0.7}Co_{0.1}Mn_{0.2}O₂, LiNi_{0.7}Co_{0.2}Mn_{0.1}O₂, LiNi_{0.8}Co_{0.1}Mn_{0.1}O₂, and LiNi_{0.9}Co_{0.05}Mn_{0.05}O₂.

The composition of the lithium-metal composite oxide may be represented by the following general formula, for example. A compound represented by the following general formula may also be called “NCA”.

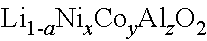

In the above formula, the relationships of −0.5≤a≤0.5, 0<x<1, 0<y<1, 0<z<1, x+y+z=1 are satisfied. For example, the relationship of 0<x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x<1 may be satisfied. For example, the relationship of 0<y≤0.1, 0.1≤y≤0.2, 0.2≤y≤0.3, 0.3≤y≤0.4, 0.4≤y≤0.5, 0.5≤y≤0.6, 0.6≤y≤0.7, 0.7≤y≤0.8, 0.8≤y≤0.9, or 0.9≤y<1 may be satisfied. For example, the relationship of 0<z≤0.1, 0.1≤z≤0.2, 0.2≤z≤0.3, 0.3≤z≤0.4, 0.4≤z≤0.5, 0.5≤z≤0.6, 0.6≤z≤0.7, 0.7≤z≤0.8, 0.8≤z≤0.9, or 0.9≤z<1 may be satisfied.

NCA may include, for example, at least one selected from the group consisting of LiNi_{0.7}Co_{0.1}Al_{0.2}O₂, LiNi_{0.7}Co_{0.2}Al_{0.1}O₂, LiNi_{0.8}Co_{0.1}Al_{0.1}O₂, LiNi_{0.8}Co_{0.17}Al_{0.03}O₂, LiNi_{0.8}Co_{0.15}Al_{0.05}O₂, and LiNi_{0.9}Co_{0.05}Al_{0.05}O₂.

NCM, NCA, and the like may also include B, and, for example, may be represented by a general formula “Li₁₋ₐNiₓM₁₋ₓO₂B_{b}”, a general formula “Li₁₋ₐNiₓCo_{y}Mn_{z}O₂B_{b}”, a general formula “Li₁₋ₐNiₓCo_{y}Al_{z}O₂B_{b}”, and/or the like.

To the lithium-metal composite oxide, a dopant other than B may be added. Only a dopant other than B may be added, or both B and a dopant other than B may be added. The amount of the dopant other than B to be added (the amount-of-substance fraction relative to the total amount of the positive electrode active material) may be from 0.01 to 5%, or from 0.1 to 3%, or from 0.1 to 1%, for example. Two or more types of dopants other than B may be added.

The dopant other than B may include, for example, at least one selected from the group consisting of C, N, a halogen, Si, Na, Mg, Al, Mn, Co, Cr, Sc, Ti, V, Cu, Zn, Ga, Ge, Se, Sr, Y, Zr, Nb, Mo, In, Pb, Bi, Sb, Sn, W, La, Ce, Pr, Nd, Pm, Sm, Eu, Gd, Tb, Dy, Ho, Er, Tm, Yb, Lu, and an actinoid.

### <Method of Producing Positive Electrode Active Material>

FIG. 5 is a schematic flowchart illustrating a method of producing a positive electrode active material according to the present embodiment. In the following, the method of producing a positive electrode active material according to the present embodiment may be simply referred to as “the present production method”. The present production method includes “(a) preparing a metal hydroxide”, “(b) mixing”, “(c) first heat treatment”, and “(d) second heat treatment”. The present production method may further include “(e) disintegration” and/or the like, for example.

### (a) Preparing Metal Hydroxide

The present production method includes preparing a metal hydroxide. The metal hydroxide is a precursor of a lithium-metal composite oxide. The metal hydroxide may be synthesized by coprecipitation and/or the like, for example. A sulfate may be prepared, for example. The sulfate may include at least one selected from the group consisting of NiSO₄, CoSO₄, MnSO₄, and Al₂(SO₄)₃, for example. The sulfate is dissolved in water to prepare a raw material solution. The mass concentration of the raw material solution may be from 10 to 50%, for example. The raw material solution may be added dropwise to an alkaline aqueous solution to precipitate the metal hydroxide. The precipitate (the metal hydroxide) may be collected by filtration, for example. After collected, the metal hydroxide may be rinsed with water. After rinsed with water, the metal hydroxide may be dried.

### (b) Mixing

The present production method includes mixing the metal hydroxide, a lithium compound, and a crystal-control material to form a first mixture. The materials may be mixed and pulverized in a mortar and/or the like, for example. “Lithium compound” refers to a Li-containing compound. The lithium compound may include at least one selected from the group consisting of LiOH and Li₂CO₃, for example. The lithium compound is a Li source for the lithium-metal composite oxide. The ratio of the amount of substance of Li to the amount of substance of the metal hydroxide (precursor) may be 0.5 or more, or 0.75 or more, or 1 or more, or 1.1 or more, or 1.25 or more, for example. This ratio may be 1.5 or less, or 1.25 or less, or 1.1 or less, or 1 or less, or 0.75 or less, for example.

The crystal-control material includes B₂O₃. It is conceivable that the combination of the crystal-control material, the first heat treatment, and the second heat treatment allows for formation of a secondary particle with radially-extending crystallites and open pores. The ratio of the amount of substance of the crystal-control material to the amount of substance of the metal hydroxide (precursor) may be from 0.001 to 0.015, for example. This ratio may be 0.0025 or more, or 0.005 or more, or 0.010 or more, for example. This ratio may be 0.010 or less, or 0.005 or less, or 0.0025 or less, for example.

### (c) First Heat Treatment, (d) Second Heat Treatment

The present production method includes performing the first heat treatment of the first mixture to form a second mixture. The present production method further includes performing a second heat treatment of the second mixture to synthesize a positive electrode active material. Each of the first heat treatment and the second heat treatment is performed in an oxygen atmosphere.

The first heat treatment is performed at a temperature from 600 to 700° C. for 6 to 12 hours. The temperature in the first heat treatment may be 650° C. or more, or 650° C. or less, for example. The duration of the first heat treatment may be 8 hours or more, or 9 hours or more, or 10 hours or more, or 11 hours or more, for example. The duration of the first heat treatment may be 11 hours or less, or 10 hours or less, or 9 hours or less, or 8 hours or less, for example.

The second heat treatment is performed at a temperature from 1100 to 1300° C. for 1 to 3 hours. The temperature in the second heat treatment may be 1150° C. or more, or 1200° C. or more, or 1250° C. or more, for example. The temperature in the second heat treatment may be 1250° C. or less, or 1200° C. or less, or 1150° C. or less, for example. The duration of the second heat treatment may be 1.5 hours or more, or 2 hours or more, or 2.5 hours or more, for example. The duration of the second heat treatment may be 2.5 hours or less, or 2 hours or less, or 1.5 hours or less, for example.

### (e) Disintegration

The present production method may include disintegration of the lithium-metal composite oxide. Any mill (for example, a jet mill) may be used. By disintegration, the particle size of the lithium-metal composite oxide may be regulated.

### Others

For example, when the present positive electrode active material is for an all-solid-state battery, secondary particles 2 may be subjected to coating treatment. The coating material may include LiNbO₃, LiTiO₃, Li₃PO₄, and/or the like, for example. The coating treatment may be performed by a mechanochemical method, a spray drying method, and/or the like, for example.

### <Secondary Battery>

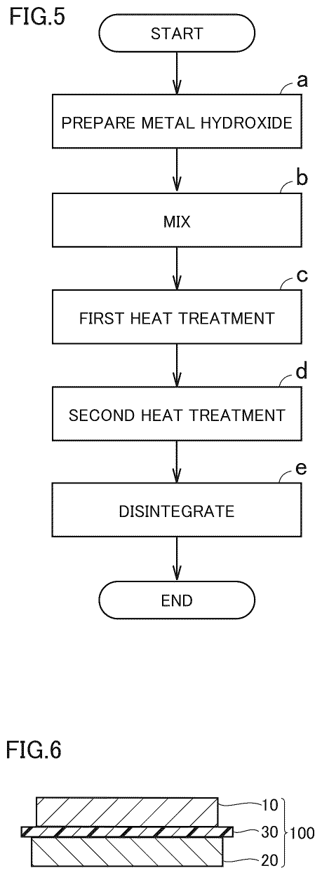

FIG. 6 is a conceptual view illustrating a secondary battery according to the present embodiment. A battery 100 is a secondary battery. “Secondary battery” refers to a rechargeable battery. Battery 100 includes a positive electrode 10, a negative electrode 20, and an electrolyte. Battery 100 may further include a separator 30. Positive electrode 10 includes the present positive electrode active material. That is, battery 100 includes the present positive electrode active material. As long as it includes the present positive electrode active material, battery 100 may have any configuration. Battery 100 may be a liquid-type battery, a polymer battery, or an all-solid-state battery, for example. Battery 100 may be a monopolar battery or a bipolar battery, for example. Positive electrode 10 and negative electrode 20 may form a power generation element. “Power generation element” may also be called a power storage element, an electrode assembly, an electrode group, and the like. The power generation element may be either a wound-type one or a stack-type one, for example.

### Exterior Package

Battery 100 may include an exterior package. The exterior package may accommodate the power generation element. The exterior package may be a case made of metal, a pouch made of a laminated film, and/or the like, for example. The case may have any shape. The case may be cylindrical, prismatic, flat, coin-shaped, and/or the like, for example. The exterior package may include Al and/or the like, for example.

### Positive Electrode

The positive electrode may be in sheet form, for example. The positive electrode may include a base material and a positive electrode active material layer, for example. The base material is electrically conductive. The base material is capable of supporting the positive electrode active material layer. The base material may be in sheet form, for example. The base material may have a thickness from 5 to 50 μm, for example. The base material may include a metal foil sheet, for example. The base material may include at least one selected from the group consisting of Al, Mn, Ti, Fe, and Cr, for example. The base material may include an Al foil sheet, an Al alloy foil sheet, a Ti foil sheet, a stainless steel (SUS) foil sheet, and/or the like, for example.

Between the base material and the positive electrode active material layer, an intermediate layer may be formed. The intermediate layer does not include a positive electrode active material. The intermediate layer may have a thickness from 0.1 to 5 μm, for example. The intermediate layer may include a conductive material, an insulation material, a binder, and/or the like, for example. The conductive material may include carbon black and/or the like, for example. The insulation material may include alumina, boehmite, aluminum hydroxide, and/or the like, for example. The binder may include polyvinylidene difluoride (PVdF) and/or the like, for example.

The positive electrode active material layer may be placed on the surface of the base material. The positive electrode active material layer may be placed on only one side of the base material. The positive electrode active material layer may be placed on both sides of the base material. The thickness of the positive electrode active material layer may be from 10 to 1000 μm, or from 50 to 500 μm, or from 100 to 300 μm, for example. The positive electrode active material layer includes the present positive electrode active material. The positive electrode active material layer may further include another positive electrode active material in addition to the present positive electrode active material. This another positive electrode active material may include lithium iron phosphate and/or the like, for example. The mass fraction of the present positive electrode active material with respect to all the positive electrode active materials may be 10% or more, or 20% or more, or 30% or more, or 40% or more, or 50% or more, or 60% or more, or 70% or more, or 80% or more, or 90% or more, for example.

The positive electrode active material layer may further include a conductive material, a binder, and the like, for example. The amount of the conductive material to be used may be, for example, from 0.1 to 10 parts by mass relative to 100 parts by mass of the positive electrode active material. The conductive material may include any component. The conductive material may include at least one selected from the group consisting of graphite, acetylene black (AB), Ketjenblack (registered trademark), vapor grown carbon fibers (VGCFs), carbon nanotubes (CNTs), and graphene flakes (GFs), for example.

The amount of the binder to be used may be, for example, from 0.1 to 10 parts by mass relative to 100 parts by mass of the positive electrode active material. The binder may include any component. The binder may include at least one selected from the group consisting of PVdF, vinylidene difluoride-hexafluoropropylene copolymer (PVdF-HFP), PTFE, carboxymethylcellulose (CMC), polyacrylic acid (PAA), polyvinyl alcohol (PVA), polyvinylpyrrolidone (PVP), polyoxyethylene alkyl ether, and derivatives of these, for example.

The positive electrode active material layer may further include an inorganic filler, an organic filler, a solid electrolyte, a surface modifier, a dispersant, a lubricant, a flame retardant, a protective agent, a flux agent, a coupling agent, an adsorbent, and/or the like, for example. The positive electrode active material layer may include polyoxyethylene allylphenyl ether phosphate, zeolite, silane coupling agent, MoS₂, WO₃, and/or the like, for example.

### Negative Electrode

Negative electrode 20 may be in sheet form, for example. The negative electrode may include a base material and a negative electrode active material layer, for example. The base material is capable of supporting the negative electrode active material layer. The base material may have a thickness from 5 to 50 μm, for example. The base material may include at least one selected from the group consisting of Cu and Ni, for example. The base material may include a Cu foil sheet, a Cu alloy foil sheet, a Ni foil sheet, and/or the like, for example.

The negative electrode active material layer may be placed on the surface of the base material. The negative electrode active material layer may be placed on only one side of the base material. The negative electrode active material layer may be placed on both sides of the base material. The thickness of the negative electrode active material layer may be from 10 to 1000 μm, or from 50 to 500 μm, or from 100 to 300 μm, for example. The negative electrode active material layer includes a negative electrode active material. The negative electrode active material layer may further include a conductive material, a binder, and the like, for example.

The amount of the conductive material to be used may be, for example, from 0.1 to 10 parts by mass relative to 100 parts by mass of the negative electrode active material. The conductive material may include any component. The conductive material may include at least one selected from the group consisting of AB, Ketjenblack, VGCFs, CNTs, and GFs, for example.

The amount of the binder to be used may be, for example, from 0.1 to 10 parts by mass relative to 100 parts by mass of the negative electrode active material. The binder may include any component. The binder may include, for example, at least one selected from the group consisting of styrene-butadiene rubber (SBR), acrylate butadiene rubber (ABR), sodium alginate, CMC (such as CMC—H, CMC—Na, CMC—Li, CMC—NH₄), PAA (such as PAA—H, PAA—Na, PAA—Li), polyacrylonitrile (PAN), PVDF, PTFE, acrylic resin, methacrylic resin, PVP, PVA, and derivatives of these. For example, the expression “CMC—Na” refers to a Na salt of CMC. For example, the expression “CMC—H” refers to an acid-type CMC. The same applies to “PAA—Na” and the like.

The negative electrode active material layer may further include an inorganic filler, an organic filler, a solid electrolyte, a surface modifier, a dispersant, a lubricant, a flame retardant, a protective agent, a flux agent, a coupling agent, an adsorbent, and/or the like, for example. The negative electrode active material layer may include a layered silicate (such as smectite, montmorillonite, bentonite, hectorite), an inorganic filler (such as solid alumina, hollow silica, boehmite), a polysiloxane compound, and/or the like, for example.

The negative electrode active material may be in particle form, or may be in sheet form, for example. The D50 of the negative electrode active material may be from 1 to 30 μm, or from 10 to 20 μm, or from 1 to 10 μm, for example.

The negative electrode active material may include a carbon-based active material, for example. The carbon-based active material may include at least one selected from the group consisting of graphite, soft carbon, and hard carbon, for example. The “graphite” collectively refers to natural graphite and artificial graphite. The graphite may be a mixture of natural graphite and artificial graphite. The mixing ratio (mass ratio) may be “(natural graphite)/(artificial graphite)=1/9 to 9/1”, or “(natural graphite)/(artificial graphite)=2/8 to 8/2”, or “(natural graphite)/(artificial graphite)=3/7 to 7/3”, for example.

The graphite may include a dopant. The dopant may include, for example, at least one selected from the group consisting of B, N, P, Li, and Ca. The amount thereof to be added in amount-of-substance fraction may be from 0.01 to 5%, or from 0.1 to 3%, or from 0.1 to 1%, for example.

The surface of the graphite may be covered with amorphous carbon, for example. The surface of the graphite may be covered with another type of material, for example. This another type of material may include, for example, at least one selected from the group consisting of P, W, Al, and O. The another type of material may include, for example, at least one selected from the group consisting of Al(OH)₃, AlOOH, Al₂O₃, WO₃, Li₂CO₃, LiHCO₃, and Li₃PO₄.

The negative electrode active material may include an alloy-based active material, for example. The negative electrode active material may include, for example, at least one selected from the group consisting of Si, Li silicate, SiO, Si-based alloy, Sn, SnO, and Sn-based alloy.

SiO may be represented by the following general formula, for example.

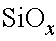

In the formula, the relationship of 0<x<2 is satisfied. For example, the relationship of 0.5≤x≤1.5 or 0.8≤x≤1.2 may be satisfied.

Li silicate may include at least one selected from the group consisting of Li₄SiO₄, Li₂SiO₃, Li₂Si₂O₅, and Li₈SiO₆, for example. The negative electrode active material may include a mixture of Si and Li silicate, for example. The mixing ratio (mass ratio) may be “Si/(Li silicate)=1/9 to 9/1”, or “Si/(Li silicate)=2/8 to 8/2”, or “Si/(Li silicate)=3/7 to 7/3”, or “Si/(Li silicate)=4/6 to 6/4”, for example.

The alloy-based active material (such as Si, SiO) may include an additive. The additive may be a substituted solid solution atom or an intruding solid solution atom, for example. The additive may be an adherent adhered to the surface of the alloy-based active material. The adherent may be an elementary substance, an oxide, a carbide, a nitride, a halide, and/or the like, for example. The amount to be added may be, in amount-of-substance fraction, from 0.01 to 5%, or from 0.1 to 3%, or from 0.1 to 1%, for example. The additive may include, for example, at least one selected from the group consisting of Li, Na, K, Rb, Be, Mg, Ca, Sr, Fe, Ba, B, Al, Ga, In, C, Ge, Sn, Pb, N, P, As, Y, Sb, and S. That is, SiO may be doped with Mg and/or Na. For example, Mg silicate and/or Na silicate may be formed. For example, boron oxide (such as B₂O₃, for example), yttrium oxide (such as Y₂O₃, for example), and/or the like may be added to SiO.

The negative electrode active material may include a composite material of the carbon-based active material (such as graphite) and the alloy-based active material (such as Si), for example. A composite material including Si and carbon may also be called “an Si—C composite material”. For example, Si microparticles may be dispersed inside carbon particles. For example, Si microparticles may be dispersed inside graphite particles. For example, Li silicate particles may be covered with a carbon material (such as amorphous carbon).

The negative electrode active material may include, for example, at least one selected from the group consisting of Li metal, Li-based alloy, and Li₄Ti₅O₁₂. The negative electrode active material may include a Li foil sheet and/or the like, for example.

### Liquid Electrolyte (Electrolyte Solution)

Battery 100 may include an electrolyte solution. In other words, battery 100 may be a liquid-type battery. The electrolyte solution includes a supporting salt and a solvent. The supporting salt is also called “a supporting electrolyte”. The concentration of the supporting salt (salt concentration) may be from 0.5 to 1 mol/L, or from 1 to 1.5 mol/L, or from 1.5 to 2 mol/L, or from 2 to 2.5 mol/L, or from 2.5 to 3 mol/L, for example. “Mol/L” may also be expressed as “M”. The supporting salt may include an inorganic acid salt, an imide salt, an oxalato complex, a halide, and/or the like, for example. The supporting salt may include at least one selected from the group consisting of LiPF₆, LiBF₄, LiClO₄, LiAsF₆, LiSbF₆, LiN(SO₂F)₂ “LiFSI”, LiN (SO₂CF₃)₂ “LiTFSI”, LiB(C₂O₄)₂ “LiBOB”, LiBF₂(C₂O₄) “LiDFOB”, LiPF₂(C₂O₄)₂ “LiDFOP”, LiPO₂F₂, FSO₃Li, LiI, LiBr, and derivatives of these, for example.

The electrolyte solution may include a carbonate-based solvent (a carbonate-ester-based solvent), for example. The solvent may include a cyclic carbonate, a chain carbonate, a fluorinated carbonate, and/or the like, for example. The solvent may include, for example, at least one selected from the group consisting of ethylene carbonate (EC), propylene carbonate (PC), butylene carbonate (BC), dimethyl carbonate (DMC), diethyl carbonate (DEC), ethyl methyl carbonate (EMC), monofluoroethylene carbonate (FEC), difluoroethylene carbonate, 4,4-difluoroethylene carbonate, trifluoroethylene carbonate, perfluoroethylene carbonate, fluoropropylene carbonate, difluoropropylene carbonate, and derivatives of these.

The solvent may include a cyclic carbonate (such as EC, PC, FEC) and a chain carbonate (such as EMC, DMC, DEC). The mixing ratio between the cyclic carbonate and the chain carbonate (volume ratio) may be “(cyclic carbonate)/(chain carbonate)=1/9 to 4/6”, or “(cyclic carbonate)/(chain carbonate)=2/8 to 3/7”, or “(cyclic carbonate)/(chain carbonate)=3/7 to 4/6”, for example.

The solvent may include a cyclic carbonate (such as EC, PC) and a fluorinated cyclic carbonate (such as FEC). The mixing ratio between the cyclic carbonate and the fluorinated cyclic carbonate (volume ratio) may be “(cyclic carbonate)/(fluorinated cyclic carbonate)=99/1 to 90/10”, or “(cyclic carbonate)/(fluorinated cyclic carbonate)=9/1 to 1/9”, or “(cyclic carbonate)/(fluorinated cyclic carbonate)=9/1 to 7/3”, or “(cyclic carbonate)/(fluorinated cyclic carbonate)=3/7 to 1/9”, for example.

The solvent may include EC, FEC, EMC, DMC, and DEC, for example. The volume ratio of these components may satisfy the relationship represented by the following equation, for example.

$${V}_{EC} + {V}_{FEC} + {V}_{EMC} + {V}_{DMC} + {V}_{DEC} = 10$$

In the equation, each of V_{EC}, V_{FEC}, V_{EMC}, V_{DMC}, and V_{DEC} represents the volume ratio of EC, FEC, EMC, DMC, and DEC, respectively.

The relationships of 1≤V_{EC}≤4, 0≤V_{FEC}≤3, V_{EC}+V_{FEC}≤4, 0≤V_{EMC}≤9, 0≤V_{DMC}≤9, 0≤V_{DEC}≤9, 6≤V_{EMC}+V_{DMC}+V_{DEC}≤9 are satisfied.

For example, the relationship of 1≤V_{EC}≤2 or 2≤V_{EC}≤3 may be satisfied.

For example, the relationship of 1≤V_{FEC}≤2 or 2≤V_{FEC}≤4 may be satisfied.

For example, the relationship of 3≤V_{EMC}≤4 or 6≤V_{EMC}≤8 may be satisfied.

For example, the relationship of 3≤V_{DMC}≤4 or 6≤V_{DMC}≤8 may be satisfied.

For example, the relationship of 3≤V_{DEC}≤4 or 6≤V_{DEC}≤8 may be satisfied.

The solvent may have a composition of “EC/EMC=3/7”, “EC/DMC-3/7”,

“EC/FEC/DEC=1/2/7”, “EC/DMC/EMC=3/4/3”, “EC/DMC/EMC-3/3/4”,

“EC/FEC/DMC/EMC=2/1/4/3”, “EC/FEC/DMC/EMC=1/2/4/3”,

“EC/FEC/DMC/EMC=2/1/3/4”, “EC/FEC/DMC/EMC=1/2/3/4” (volume ratio), and/or the like, for example.

The electrolyte solution may include an ether-based solvent. The electrolyte solution may include, for example, at least one selected from the group consisting of tetrahydrofuran (THF), 1,4-dioxane (DOX), 1,3-dioxolane (DOL), 1,2-dimethoxyethane (DME), 1,2-diethoxyethane (DEE), hydrofluoroether (HFE), ethylglyme, triglyme, tetraglyme, and derivatives of these.

The electrolyte solution may include any additive. The amount to be added (the mass fraction to the total amount of the electrolyte solution) may be from 0.01 to 5%, or from 0.05 to 3%, or from 0.1 to 1%, for example. The additive may include an SEI (Solid Electrolyte Interphase) formation promoter, an SEI formation inhibitor, a gas generation agent, an overcharging inhibitor, a flame retardant, an antioxidant, an electrode-protecting agent, a surfactant, and/or the like, for example.

The additive may include, for example, at least one selected from the group consisting of vinylene carbonate (VC), vinylethylene carbonate (VEC), 1,3-propane sultone (PS), tert-amylbenzene, 1,4-di-tert-butylbenzene, biphenyl (BP), cyclohexylbenzene (CHB), ethylene sulfite(ES), ethylene sulfate (DTD), γ-butyrolactone, phosphazene compound, carboxylate ester [such as methyl formate (MF), methyl acetate (MA), methyl propionate (MP), diethyl malonate (DEM), for example], fluorobenzene (such as monofluorobenzene (FB), 1,2-difluorobenzene, 1,3-difluorobenzene, 1,4-difluorobenzene, 1,2,3-trifluorobenzene, 1,2,4-trifluorobenzene, 1,3,5-trifluorobenzene, 1,2,3,4-tetrafluorobenzene, 1,2,3,5-tetrafluorobenzene, 1,2,4,5-tetrafluorobenzene, pentafluorobenzene, hexafluorobenzene, for example), fluorotoluene (such as 2-fluorotoluene, 3-fluorotoluene, 4-fluorotoluene, 2,3-difluorotoluene, 2,4-difluorotoluene, 2,5-difluorotoluene, 2,6-difluorotoluene, 3,4-difluorotoluene, octafluorotoluene, for example), benzotrifluoride (such as benzotrifluoride, 2-fluorobenzotrifluoride, 3-fluorobenzotrifluoride, 4-fluorobenzotrifluoride, 2-methylbenzotrifluoride, 3-methylbenzotrifluoride, 4-methylbenzotrifluoride, for example), fluoroxylene (such as 3-fluoro-o-xylene, 4-fluoro-o-xylene, 2-fluoro-m-xylene, 5-fluoro-m-xylene, for example), sulfur-containing heterocyclic compound (such as benzothiazole, 2-methylbenzothiazole, tetrathiafulvalene, for example), nitrile compound (such as adiponitrile, succinonitrile, for example), phosphate (such as trimethyl phosphate, triethyl phosphate, for example), carboxylic anhydride (such as acetic anhydride, propionic anhydride, oxalic anhydride, succinic anhydride, maleic anhydride, phthalic anhydride, benzoic anhydride, for example), alcohol (such as methanol, ethanol, n-propyl alcohol, ethylene glycol, diethylene glycol monomethyl ether, for example), and derivatives of these.

The components described above as the supporting salt and the solvent may be used as a trace component (an additive). The additive may include, for example, at least one selected from the group consisting of LiBF₄, LiFSI, LiTFSI, LiBOB, LiDFOB, LiDFOP, LiPO₂F₂, FSO₃Li, LiI, LiBr, HFE, DOX, PC, FEC, and derivatives of these.

The electrolyte may include an ionic liquid. The ionic liquid may include, for example, at least one selected from the group consisting of a sulfonium salt, an ammonium salt, a pyridinium salt, a piperidinium salt, a pyrrolidinium salt, a morpholinium salt, a phosphonium salt, an imidazolium salt, and derivatives of these.

### Gelled Electrolyte

The electrolyte solution and a polymer material may form a gelled electrolyte.

In other words, battery 100 may be a polymer battery. The polymer material may form a polymer matrix. The polymer material may include, for example, at least one selected from the group consisting of PVdF, PVdF-HFP, PAN, PVdF-PAN, polyethylene oxide (PEO), polyethylene glycol (PEG), and derivatives of these.

### Solid Electrolyte

Battery 100 may include a solid electrolyte. In other words, battery 100 may be an all-solid-state battery. The solid electrolyte may be in powder form, for example. The D50 of the solid electrolyte may be from 0.1 to 3 μm, for example.

The solid electrolyte may include a sulfide solid electrolyte, for example. The sulfide solid electrolyte may be glass ceramic, or may be argyrodite, for example. The sulfide solid electrolyte may include at least one selected from the group consisting of LiI—LiBr—Li₃PS₄, Li₂S—SiS₂, LiI—Li₂S—SiS₂, LiI—Li₂S—P₂S₅, LiI—Li₂O—Li₂S—P₂S₅, LiI—Li₂S—P₂O₅, LiI—Li₃PO₄—P₂S₅, Li₂S—GeS₂—P₂S₅, Li₂S—P₂S₅, Li₁₀GeP₂S₁₂, Li₄P₂S₆, Li₇P₃S₁₁, Li₃PS₄, Li₇PS₆, and Li₆PS₅X (X=Cl, Br, I), for example.

For example, “LiI—LiBr—Li₃PS₄” refers to a sulfide solid electrolyte produced by mixing “LiI, LiBr, and Li₃PS₄” in a freely-selected molar ratio. For example, the sulfide solid electrolyte may be produced by a mechanochemical method. “Li₂S—P₂S₅” includes Li₃PS₄. Li₃PS₄ may be produced by mixing Li₂S and P₂S₅ in “a molar ratio of Li₂S/P₂S₅=75/25”, for example.

The solid electrolyte may include a halide solid electrolyte, for example. The halide solid electrolyte may have a composition represented by the following general formula, for example.

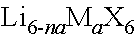

In the formula, n represents the oxidation number of M. For example, M may include an atom whose oxidation number is +3. For example, M may include an atom whose oxidation number is +4. M may include at least one selected from the group consisting of Y, Al, Ti, Zr, Ca, and Mg, for example. The relationship of 0<a<2 may be satisfied. X may include at least one selected from the group consisting of F, Cl, Br, and I, for example.

The halide solid electrolyte may have a composition represented by the following general formula, for example.

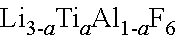

In the formula, the relationship of 0≤a≤0.1, 0.1≤a≤0.2, 0.2≤a≤0.3, 0.3≤a≤0.4, 0.4≤a≤0.5, 0.5≤a≤0.6, 0.6≤a≤0.7, 0.7≤a≤0.8, 0.8≤a≤0.9, or 0.9≤a≤1 may be satisfied, for example.

The halide solid electrolyte may have a composition represented by the following general formula, for example.

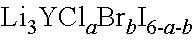

In the formula, the relationship of 0≤a+b≤6 is satisfied. For example, the relationship of 0≤a≤1, 1≤a≤2, 2≤a≤3, 3≤a≤4, 4≤a≤5, or 5≤a≤6 may be satisfied. For example, the relationship of 0≤b≤1, 1≤b≤2, 2≤b≤3, 3≤b≤4, 4≤b≤5, or 5≤b≤6 may be satisfied.

The solid electrolyte may include an oxide solid electrolyte, for example. The oxide solid electrolyte may include at least one selected from the group consisting of LiNbO₃, Li_{1.5}Al_{0.5}Ge_{1.5}(PO₄)₃, La_{2/3-x}Li₃ₓTiO₃, and Li₇La₃Zr₂O₁₂, for example.

The solid electrolyte may include a hydride solid electrolyte, for example. The hydride solid electrolyte may include LiBH₄ and/or the like, for example. The solid electrolyte may include a nitride solid electrolyte, for example. The nitride solid electrolyte may include Li₃N, Li₃BN₂, and/or the like, for example.

### Separator

Battery 100 may include separator 30. Separator 30 is capable of separating positive electrode 10 from negative electrode 20. Separator 30 is electrically insulating. Separator 30 may include a resin film, for example. The resin film is porous. The resin film may include a microporous film, a nonwoven fabric, and/or the like, for example. The resin film includes a resin skeleton. The resin skeleton may be continuous in mesh form, for example. Gaps in the resin skeleton form pores.

The average pore size of the resin film may be from 0.01 to 1 μm, or from 0.1 to 0.5 μm, for example. “Average pore size” may be measured by mercury porosimetry. The Gurley value of the resin film may be from 50 to 250 s/100 cm³, for example. “Gurley value” may be measured by a Gurley test method.

The resin film may include, for example, at least one selected from the group consisting of an olefin-based resin, a polyurethane-based resin, a polyamide-based resin, a cellulose-based resin, a polyether-based resin, an acrylic-based resin, a polyester-based resin, and the like. The resin film may include, for example, at least one selected from the group consisting of polyethylene (PE), polypropylene (PP), polyamide (PA), polyamide-imide (PAI), polyimide (PI), aromatic polyamide (aramid), and polyphenylene ether (PPE), and derivatives of these. The resin film may be formed by stretching, phase separation, and/or the like, for example. The resin film may have a thickness from 5 to 50 μm, or from 10 to 25 μm, for example.

The resin film may have a monolayer structure. The resin film may consist of a PE layer, for example. A skeleton of a PE layer is formed of PE. The PE layer may have shut-down function. The resin film may have a multilayer structure, for example. The resin film may include a PP layer and a PE layer, for example. A skeleton of a PP layer is formed of PP. The resin film may have a three-layer structure, for example. The resin film may be formed by stacking a PP layer, a PE layer, and a PP layer in this order, for example. The thickness of the PE layer may be from 5 to 20 μm, for example. The thickness of the PP layer may be from 3 to 10 μm, for example.

In an all-solid-state battery, the solid electrolyte layer is capable of functioning as separator 30.

### Battery Configuration

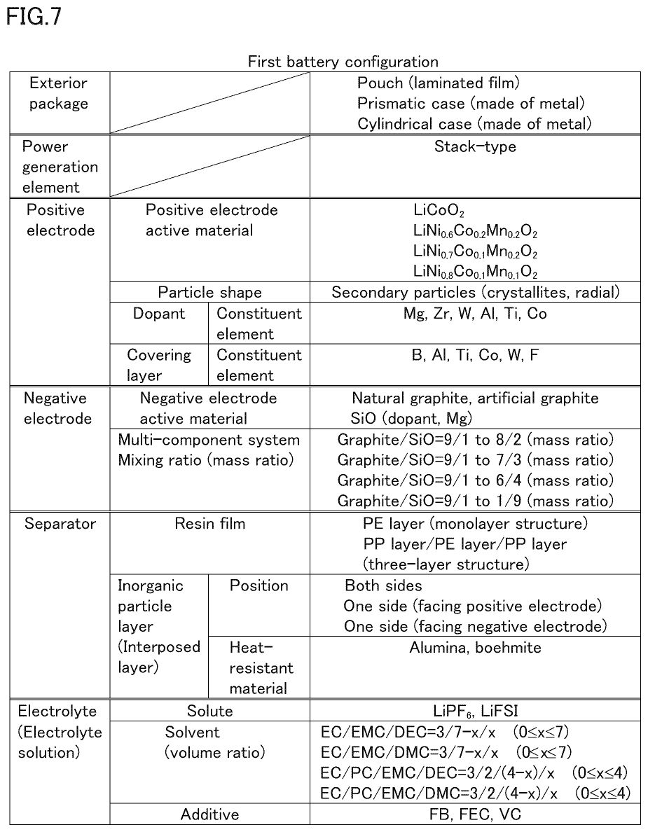

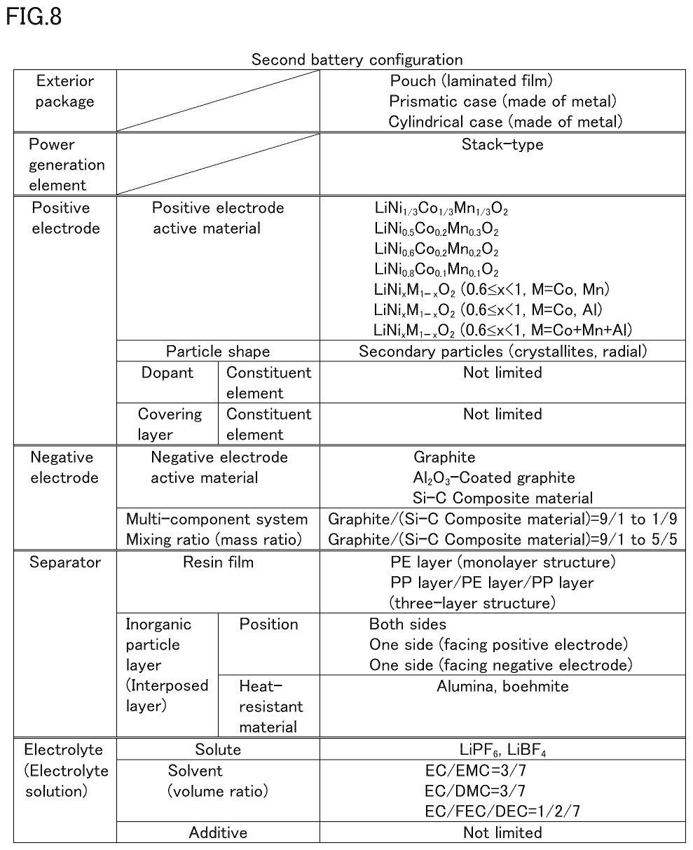

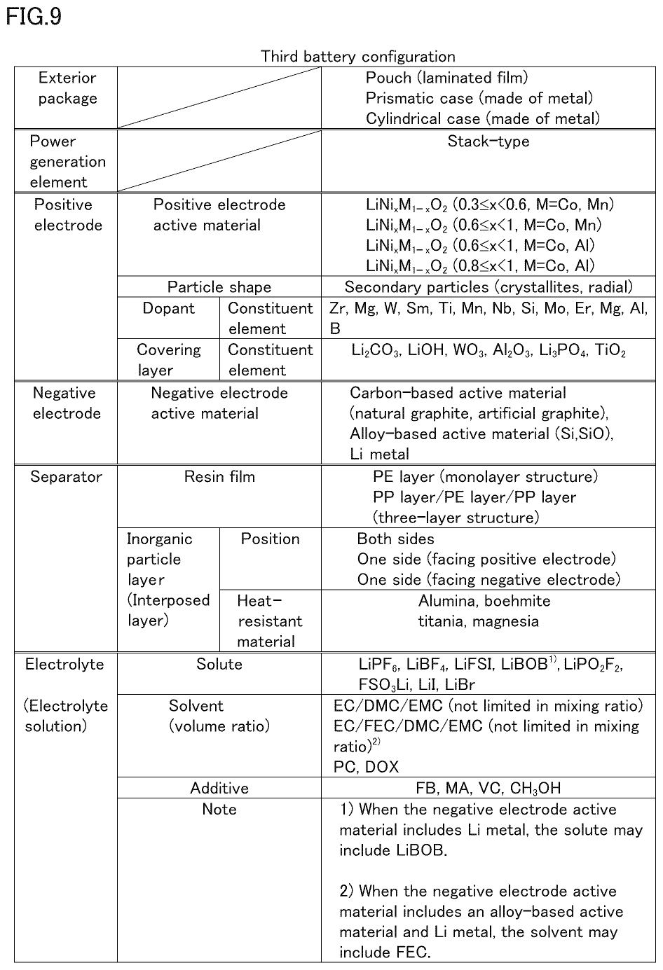

FIG. 7 is a table showing a first battery configuration. FIG. 8 is a table showing a second battery configuration. FIG. 9 is a table showing a third battery configuration. Each battery configuration is an example of the configuration of a liquid-type battery or a polymer battery. Part of each battery configuration may be applied to an all-solid-state battery. In each drawing, when a plurality of types of materials are described in a single cell, this description is intended to mean one of them as well as a combination of them. For example, when materials “α, β, γ” are described in a single cell, this description is intended to mean “at least one selected from the group consisting of α, β, and γ”. Certain elements in these battery configurations may be optionally combined together.

### Examples

### <Production of Positive Electrode Active Material>

### No. 1

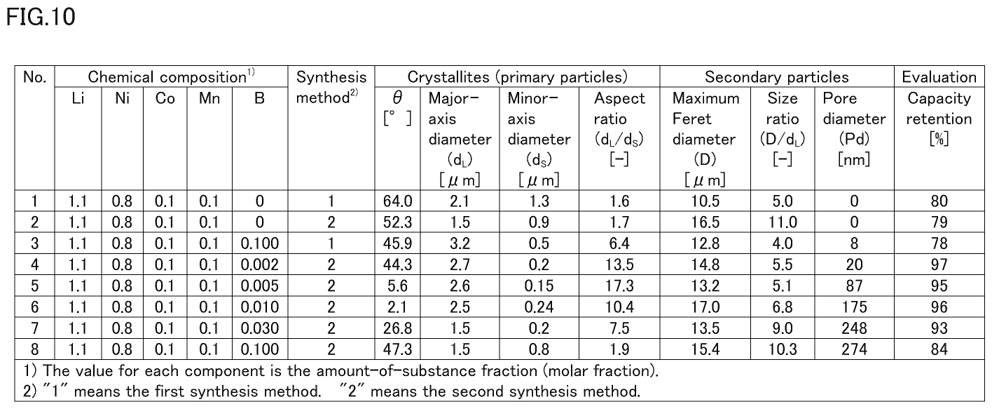

FIG. 10 is a table showing experiment results. By a first synthesis method, a positive electrode active material of No. 1 was produced. NiSO₄, CoSO₄, and MnSO₄ were dissolved in ion-exchanged water to form a raw material solution. In the raw material solution, the molar ratio between Ni, Co, and Mn was “Ni/Co/Mn=8/1/1”. The concentration of the solute in the raw material solution was 30% (mass fraction).

Into a reaction vessel, an aqueous ammonia solution was added. While the aqueous ammonia solution was being stirred with a stirrer, inside the reaction vessel was replaced by nitrogen. Into the reaction vessel, NaOH was further added, and thereby a reaction liquid was formed.

The raw material solution and the aqueous ammonia solution were added dropwise to the reaction liquid so that the pH of the reaction liquid was maintained within a certain range, and thereby a precipitate (metal hydroxide) was formed. The reaction liquid was filtrated to collect the metal hydroxide. The metal hydroxide was dispersed in ion-exchanged water to form a dispersion. The dispersion was sufficiently stirred with a spatula. In other words, the metal hydroxide was rinsed with water. After rinsed with water, the dispersion was filtrated to collect the metal hydroxide. The metal hydroxide was dried at 120° C. for 16 hours, and thereby a dried product was formed.

The dried product and a lithium compound (Li₂CO₃) were mixed together in a mortar to form a mixture. The ratio of the amount of substance of Li to the amount of substance of the metal hydroxide was 1.1.

The mixture was subjected to heat treatment in a muffle furnace, and thereby a lithium-metal composite oxide was synthesized. The heat treatment was performed in one step. The conditions of the heat treatment were as specified below. After the heat treatment, the particle size of the lithium-metal composite oxide was regulated with the use of a jet mill.
Atmosphere: Oxygen atmosphere
Temperature: 800 to 1100° C.
Duration: 10 hours.

### No. 2

By a second synthesis method, a positive electrode active material of No. 2 was produced. The second synthesis method is different from the first synthesis method in terms of heat treatment. NiSO₄, CoSO₄, and MnSO₄ were dissolved in ion-exchanged water to form a raw material solution. In the raw material solution, the molar ratio between Ni, Co, and Mn was “Ni/Co/Mn=8/1/1”. The concentration of the solute in the raw material solution was 30% (mass fraction).

Into a reaction vessel, an aqueous ammonia solution was added. While the aqueous ammonia solution was being stirred with a stirrer, inside the reaction vessel was replaced by nitrogen. Into the reaction vessel, NaOH was further added, and thereby a reaction liquid was formed.

The raw material solution and the aqueous ammonia solution were added dropwise to the reaction liquid so that the pH of the reaction liquid was maintained within a certain range, and thereby a precipitate (metal hydroxide) was formed. The reaction liquid was filtrated to collect the metal hydroxide. The metal hydroxide was dispersed in ion-exchanged water to form a dispersion. The dispersion was sufficiently stirred with a spatula. In other words, the metal hydroxide was rinsed with water. After rinsed with water, the dispersion was filtrated to collect the metal hydroxide. The metal hydroxide was dried at 120° C. for 16 hours, and thereby a dried product was formed.

The dried product and a lithium compound (Li₂CO₃) were mixed together in a mortar to form a mixture. The ratio of the amount of substance of Li to the amount of substance of the metal hydroxide was 1.1.

In a muffle furnace, a first heat treatment and a second heat treatment were performed in this order, and thereby a lithium-metal composite oxide was synthesized. The conditions of the heat treatment were as specified below. After the heat treatment, the particle size of the lithium-metal composite oxide was regulated with the use of a jet mill.
First heat treatment
Atmosphere: Oxygen atmosphere
Temperature: 600 to 700° C.
Duration: 10 hours
Second heat treatment
Atmosphere: Oxygen atmosphere
Temperature: 1100 to 1300° C.
Duration: 2 hours

### No. 3

A positive electrode active material was produced in the same manner as in No. 1 except that a crystal-control material (B₂O₃) was added at the time when the dried product (metal hydroxide) and the lithium compound (Li₂CO₃) were mixed together in a mortar. The ratio of the amount of substance of the crystal-control material to the amount of substance of the metal hydroxide was 0.100.

### No. 4

A positive electrode active material was produced in the same manner as in No. 2 except that a crystal-control material (B₂O₃) was added at the time when the dried product (metal hydroxide) and the lithium compound (Li₂CO₃) were mixed together in a mortar. The ratio of the amount of substance of the crystal-control material to the amount of substance of the metal hydroxide was 0.001.

### No. 5 to No. 8

A positive electrode active material was produced in the same manner as in No. 4 except that the amount of the crystal-control material (B₂O₃) to be added was changed.

### <Evaluation>

A cylindrical lithium-ion secondary battery (an evaluation cell) was produced.

The configuration of the evaluation cell is as described below.

Power generation element: Wound type

Positive electrode: Positive electrode active material/AB/PVDF=88/10/2 (mass ratio)

Negative electrode: Negative electrode active material (natural graphite), CMC,

SBR

Electrolyte: LiPF₆ (1 mol/L), EC/DMC/EMC=3/4/3 (volume ratio)

Each of the positive electrode and the negative electrode was produced by applying a slurry to the surface of a base material (a metal foil sheet). As the application apparatus, a film applicator manufactured by Allgood (having film-thickness adjuster function) was used. After the slurry application, the coating film was dried at 80° C. for 5 minutes.

The evaluation cell was subjected to endurance testing. More specifically, in an environment at room temperature, at a constant current of 2 C, at a voltage within the range of 3.0 to 4.1 V, 200 cycles of charge and discharge were carried out. The discharged capacity at the 200th cycle was divided by the discharged capacity at the 1st cycle to determine the capacity retention (in percentage). It is conceivable that the higher the capacity retention is, the better the endurance is.

### <Results>

As seen in FIG. 10, endurance is enhanced in No. 4 to No. 8 as compared to No. 1 to No. 3. In No. 4 to No. 8, crystallites extended radially. In No. 4 to No. 8, open pores with a pore diameter of 20 nm or more were observed.

In No. 4 to No. 7, endurance is enhanced as compared to No. 8. In No. 4 to No. 7, the relationship of “6.4≤d_{L}/d_{S}≤17.3” is satisfied. In No. 4 to No. 7, the pore diameter of the open pores is less than 250 nm. In No. 4 to No. 7, the relationship of “4.0≤D/d_{L}≤9.0” is satisfied. In No. 4 to No. 7, the relationship of “θ≤45°” is satisfied.

What is claimed is:

1. A positive electrode active material comprising:
a secondary particle, wherein
the secondary particle includes crystallites,
the crystallites extend radially from a center of the secondary particle toward outside,
each of the crystallites includes a lithium-metal composite oxide,
the lithium-metal composite oxide has a lamellar-rock-salt-type structure,
in a surface of the secondary particle, an open pore is formed between the crystallites that are adjacent to each other, and
the open pore has a pore diameter of 20 nm or more.

2. The positive electrode active material according to claim 1, wherein in a cross section of the secondary particle, a relationship below is satisfied:
$$θ \leq 45 °$$
where θ represents an angle formed by a first straight line and a second straight line,
the first straight line is an extension of a major-axis diameter of the crystallite, and
the second straight line passes both a point of intersection between the extension and a circumcircle of the secondary particle, and a center of the circumcircle.

3. The positive electrode active material according to claim 1, wherein the pore diameter of the open pore is less than 250 nm.

4. The positive electrode active material according to claim 1, wherein
in a cross section of the secondary particle, a relationship below is satisfied:
$$6.4 \leq {d}_{L} / {d}_{S} \leq 17.3$$
where
d_{L} represents a major-axis diameter of the crystallite, and
d_{S} represents a minor-axis diameter of the crystallite.

5. The positive electrode active material according to claim 1, wherein in a cross section of the secondary particle, a relationship below is satisfied:
$$4. \leq D / {d}_{L} \leq 9.0$$
where
D represents a maximum Feret diameter of the secondary particle, and
d_{L} represents a major-axis diameter of the crystallite.

6. The positive electrode active material according to claim 1, wherein
the lithium-metal composite oxide has a composition represented by a general formula:
$${Li}_{1 - a} {MO}_{2}$$
where
a relationship of −0.5≤a≤0.5 is satisfied, and
M includes at least one selected from the group consisting of Ni, Co, Mn, and Al.

7. The positive electrode active material according to claim 1, wherein
the lithium-metal composite oxide has a composition represented by a general formula:
$${Li}_{1 - a} {MO}_{2} {B}_{b}$$
where
relationships of −0.5≤a≤0.5 and 0.002≤b≤0.030 are satisfied, and M includes at least one selected from the group consisting of Ni, Co, Mn, and Al.

8. A secondary battery comprising the positive electrode active material according to claim 1.

9. A method of producing a positive electrode active material, the method comprising:
(a) preparing a metal hydroxide;
(b) mixing the metal hydroxide, a lithium compound, and a crystal-control material to form a first mixture;
(c) performing a first heat treatment of the first mixture to form a second mixture; and
(d) performing a second heat treatment of the second mixture to synthesize a positive electrode active material, wherein
the crystal-control material includes B₂O₃,
each of the first heat treatment and the second heat treatment is performed in an oxygen atmosphere,
the first heat treatment is performed at a temperature from 600 to 700° C. for 6 to 12 hours, and
the second heat treatment is performed at a temperature from 1100 to 1300° C. for 1 to 3 hours.
